(19) United States
(12) Patent Application Publication
(10) Pub. No.: US 2023/0385624 A1
(43) Pub. Date: Nov. 30, 2023

(54) COMPUTING IN MEMORY WITH ARTIFICIAL NEURONS

(71) Applicants: Sarma VRUDHULA, Chandler, AZ (US); Ankit WAGLE, Tempe, AZ (US); Gian SINGH, Tempe, AZ (US)

(72) Inventors: Sarma VRUDHULA, Chandler, AZ (US); Ankit WAGLE, Tempe, AZ (US); Gian SINGH, Tempe, AZ (US)

(73) Assignee: Arizona Board of Regents on behalf of Arizona State University, Scottsdale, AZ (US)

(21) Appl. No.: 18/324,858

(22) Filed: May 26, 2023

Related U.S. Application Data
(60) Provisional application No. 63/365,463, filed on May 27, 2022.

(51) Int. Cl. G06N 3/063

(52) U.S. Cl. CPC G06N 3/063

(57) ABSTRACT

A system and method for computing in memory with artificial neurons. According to an embodiment of the present disclosure, there is provided a system, including: a computer-readable memory; a neuron processing element communicatively connected to the computer-readable memory, the neuron processing element including: a plurality of configurable processing circuits each having a plurality of outputs and a plurality of inputs; and a network connecting one or more of the outputs of the configurable processing circuits to one or more of the inputs of the configurable processing circuits, each of the configurable processing circuits including: an artificial neuron having a plurality of inputs; and a register connected to the inputs of the artificial neuron.

### CROSS-REFERENCE TO RELATED APPLICATION(S)

The present application claims priority to and the benefit of U.S. Provisional Application No. 63/365,463, filed May 27, 2022, entitled “CIDAN-XE: COMPUTING IN DRAM WITH ARTIFICIAL NEURONS”, the entire content of which is incorporated herein by reference.

### STATEMENT REGARDING FEDERALLY SPONSORED RESEARCH OR DEVELOPMENT

This invention was made with government support under 1361926 and 2008244 awarded by the National Science Foundation. The government has certain rights in the invention.

### FIELD

One or more aspects of embodiments according to the present disclosure relate to computation, and more particularly to a system and method for computing in memory with artificial neurons.

### BACKGROUND

The continuing exponential growth in the number of electronic systems that access the internet combined with an increasing emphasis on data analytics is giving rise to applications that continuously process terabytes of data. The latency and energy consumption of such data-intensive or data-centric (Gokhale et al., Computer, 41(4):60-68, 2008) applications is dominated by the movement of the data between the processor and memory. In modern systems about 60% of the total energy is consumed by the data movement over the limited bandwidth channel between the processor and memory (Boroumand et al., ACM SIGPLAN Notices, 53(2):316-331, November 2018). The recent growth of data-intensive applications is due to the proliferation of machine learning techniques which may be implemented using convolutional/deep neural networks (CNNs/DNNs) (Angizi et al., 2019 IEEE Computer Society Annual Symposium on VLSI (ISVLSI), page 197-202, July 2019). CNNs/DNNs are large computation graphs with huge storage requirements. For instance, even a relatively early neural network such as VGG-19 (Simonyan & Zisserman, CoRR, abs/1409.1556, 2015) consists of 19 layers, has about 144 million parameters, and performs about 19.6 billion operations. Almost all of the neural networks used today are much larger than VGG-19 (Dai et al., Coatnet: Marrying convolution and attention for all data sizes, 2021). These large computation graphs are evaluated in massive data centers that house millions of high-performance servers with arrays of multi-core central processing units (CPUs) and graphics processing units (GPUs). For instance, to process one image using the VGG-19 network, a TITAN X GPU takes about 2.35s, consumes about 5 joules of energy, and operates at about 228 W of power (Li et al., 2016 IEEE International Conferences on Big Data and Cloud Computing (BDCloud), Social Computing and Networking (SocialCom), Sustainable Computing and Communications (SustainCom) (BDCloud-SocialCom-SustainCom), pages 477-484, 2016). Other data-intensive applications include large scale encryption/decryption programs (G. Myers, JACM'99, 46(3):395-415, May 1999), large-scale graph processing (Angizi & Fan, GLSVLSI '19: Great Lakes Symposium on VLSI 2019, page 45-50, May 2019), bio-informatics (Huangfu et al., Proceedings of the 52nd Annual IEEE/ACM International Symposium on Microarchitecture, MICRO '52, page 587-599. Association for Computing Machinery, October 2019), to name just a few. Each transaction over the memory channel consumes about three orders of magnitude greater energy than executing a floating-point operation on the processor, and requires almost two orders of magnitude greater latency than accessing the on-chip cache (Bill Dally, Challenge for future computer systems. https://www.cs.colostate.edu/—cs575d1/Sp2015/Lectures/Dally2015.pdf, 2015). Thus, the present approach to executing data-intensive applications using CPUs and GPUs is fast becoming unsustainable, both in terms of its limited performance and high energy consumption.

One approach to circumvent the processor-memory bottleneck is known as processing-in-memory (PIM). The dominant choice of memory in PIM is DRAM due to its large capacity (tens to hundreds of gigabytes) and the high degree of parallelism it offers because a single DRAM command can operate on an entire row containing kilobytes of data. The main idea in PIM is to perform computations within the DRAM directly without involving the CPU. Only the control signals are exchanged between the processor and the off-chip memory indicating the start and the end of the operation. This leads to a great reduction in data movement and can lead to orders of magnitude improvement in both throughput and energy efficiency as compared to traditional processors. For instance, PIM architectures such as ReDRAM (Angizi & Fan, 2019 IEEE/ACM International Conference on Computer-Aided Design (ICCAD), page 1-8, November 2019) are about 49×faster and consume about 21×less energy than a processor with GPUs for graph analysis applications. Similarly, SIMDRAM (Hajinazar et al., ASPLOS '21: 26th ACM International Conference on Architectural Support for Programming Languages and Operating Systems, page 329-345, April 2021) is about 88×/5.8×faster and 257×/31×more energy efficient than a CPU/GPU for a set of 16 basic operations.

For the widespread adoption of PIM using the DRAM platform, there may be minimum disruption to the memory array structure and the access protocol of DRAM. Being an extremely cost-sensitive market, DRAM fabrication processes are highly optimized to produce dense memories. The design and optimization of DRAM requires very high levels of expertise in process technology, device physics, custom IC layout, and analog and digital design. Consequently, a PIM architecture that is non-intrusive—meaning that it does not interfere with the DRAM array or its timing—may be advantageous.

### SUMMARY

According to an embodiment of the present disclosure, there is provided a system, including: a computer-readable memory; a neuron processing element communicatively connected to the computer-readable memory, the neuron processing element including: a plurality of configurable processing circuits each having a plurality of outputs and a plurality of inputs; and a network connecting one or more of the outputs of the configurable processing circuits to one or more of the inputs of the configurable processing circuits, each of the configurable processing circuits including: an artificial neuron having a plurality of inputs; and a register connected to the inputs of the artificial neuron.

In some embodiments, the system further includes a controller, communicatively connected to the neuron processing element, the controller being configured to provide configuration instructions to the neuron processing element.

In some embodiments, the system further includes a processor configured to send instructions to the controller, to cause the controller to provide the configuration instructions to the neuron processing element.

In some embodiments, the computer-readable memory is on an integrated circuit, and the neuron processing element is on the integrated circuit.

In some embodiments, a first configurable processing circuit of the configurable processing circuits includes a plurality of multiplexers, each of the multiplexers having: a plurality of data inputs, and an output connected to a respective input of the artificial neuron of the first configurable processing circuit.

In some embodiments, one data input of a multiplexer of the plurality of multiplexers is connected to the output of the artificial neuron of the first configurable processing circuit.

In some embodiments, a respective output of each of the other artificial neurons of the neuron processing element is connected to a respective data input of a multiplexer of the plurality of multiplexers.

In some embodiments, a first data input of a multiplexer of the plurality of multiplexers is connected to a constant 1 and a second data input of a multiplexer of the plurality of multiplexers is connected to a constant 0.

In some embodiments, each of the artificial neurons has at least three inputs.

In some embodiments, the neuron processing element includes at least three configurable processing circuits.

In some embodiments, each of the artificial neurons includes at least two input networks, each including an input and an output.

In some embodiments, each of the artificial neurons further includes a sense amplifier connected to the outputs of the at least two input networks of the artificial neuron.

In some embodiments, the neuron processing element is configured to read an input from a bank of the computer-readable memory and write a result back to the same bank of the computer-readable memory.

In some embodiments, the neuron processing element is configured to read an input from a first bank of the computer-readable memory and write a result back to a second bank of the computer-readable memory, the second bank being different from the first bank.

According to an embodiment of the present disclosure, there is provided a method, including: providing a computer-readable memory having a neuron processing element communicatively connected to the computer-readable memory, the neuron processing element including a plurality of artificial neurons; storing a set of input values in a first bank of the computer-readable memory; transmitting the set of input values and a plurality of control signals to the neuron processing element; setting a threshold function at each of the set of artificial neurons based on the control signals; calculating a result with the neuron processing element; and storing the result in the computer-readable memory.

In some embodiments, the storing of the result in the computer-readable memory includes storing the result in the first bank of the computer-readable memory.

In some embodiments, the method further includes: calculating a set of control signals for a plurality of multiplexers in the neuron processing element; and connecting outputs of the artificial neurons in the neuron processing element to inputs of the artificial neurons in the neuron processing element by setting select lines of the plurality of multiplexers in the neuron processing element.

In some embodiments, the method further includes storing an input value of the set of input values in a register in the neuron processing element.

In some embodiments, the method further includes: storing a set of outputs of the artificial neurons in a register in the neuron processing element; changing the threshold function at each of the set of artificial neurons; transmitting the set of outputs in the register to the inputs of the artificial neurons; and calculating a second set of outputs of the artificial neurons.

In some embodiments, the method further includes: calculating a set of control signals for a plurality of multiplexers in the neuron processing element; and connecting bits of the register in the neuron processing element to inputs of the artificial neurons in the neuron processing element by setting select lines of the plurality of multiplexers in the neuron processing element.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 depicts a top-level DRAM architecture, according to an embodiment of the present disclosure;

FIG. 2 depicts important timing constraints of DRAM, according to an embodiment of the present disclosure;

FIG. 3 depicts an Artificial Neuron (AN) hardware architecture, according to an embodiment of the present disclosure;

FIG. 4A, depicts an exemplary hardware architecture Neuron Processing Element (NPE), according to an embodiment of the present disclosure;

FIG. 4B depicts a configurable processing circuit, according to an embodiment of the present disclosure;

FIG. 4C depicts a single AN, according to an embodiment of the present disclosure;

FIG. 5A, depicts a 4-bit addition operation schedule on an NPE, according to an embodiment of the present disclosure;

FIG. 5B depicts an m-bit accumulation operation schedule on an NPE, according to an embodiment of the present disclosure;

FIG. 5C depicts a comparison schedule on NPE, according to an embodiment of the present disclosure;

FIG. 6A depicts a 4-bit multiplication operation schedule on an NPE, according to an embodiment of the present disclosure;

FIG. 6B depicts a multiplication schedule using partial products of decomposed operands on an NPE, according to an embodiment of the present disclosure;

FIG. 7 is a diagram depicting a max-pooling operation on a 2×2 pooling window, according to an embodiment of the present disclosure;

FIG. 8A depicts a DRAM bank organization, according to an embodiment of the present disclosure;

FIG. 8B depicts integration of NPE with a DRAM bank, according to an embodiment of the present disclosure;

FIG. 8C depicts a three-dimensional memory, according to an embodiment of the present disclosure;

FIG. 9A depicts the system-level integration of DRAM, according to an embodiment of the present disclosure;

FIG. 9B depicts the activation commands to different banks within four bank activation windows, according to an embodiment of the present disclosure;

FIG. 10A depicts convolution operations with important parameters, according to an embodiment of the present disclosure;

FIG. 10B depicts data mapping into DRAM banks for the convolution layer, according to an embodiment of the present disclosure; and

FIG. 11 is a diagram of a computing device, according to an embodiment of the present disclosure.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Certain embodiments may include in-DRAM computing which is defined herein as computation or computing that takes advantage of extreme data parallelism in Dynamic Random Access Memory (DRAM). In some embodiments, a processing unit performing in-DRAM computing as contemplated herein may be located in the same integrated circuit (IC) as a DRAM IC, or may in other embodiments be located in a different integrated circuit, but on the same daughterboard or dual in-line memory module (DIMM) as one or more DRAM IC, and may thus have more efficient access to data stored in one or more DRAM ICs on the DIMM. It is understood that although certain embodiments of systems disclosed herein may be presented as examples in specific implementations, for example using specific DRAM ICs or architectures, these examples are not meant to be limiting, and the systems and methods disclosed herein may be adapted to other DRAM architectures, including but not limited to Embedded DRAM (eDRAM), High Bandwidth Memory (HBM), or dual-ported video RAM. The systems and methods may also be implemented in non-volatile memory based crossbar structures, including but not limited to Resistive Random-Access Memory (ReRAM), Memristor, Magnetoresistive Random-Access Memory (MRAM), Phase-Change Memory (PCM), Ferroelectric RAM (FeRAM), Spin-Orbit Torque Magnetic Random Access Memory (SOT-MRAM) or Flash memory.

The system may also include in-memory computation (IMC) (or in-memory computing) which is the technique of running computer calculations entirely in computer memory (e.g., in RAM). In some embodiments, in-memory computation is implemented by modifying the memory peripheral circuitry, for example by leveraging a charge sharing or charge/current/resistance accumulation scheme by one or more of the following methods: modifying the sense amplifier and/or decoder, replacing the sense amplifier with an analog-to-digital converter (ADC), adding logic gates after the sense amplifier, or using a different DRAM cell design. In some embodiments, additional instructions are available for special-purpose IMC ICs.

The system may also include processing in memory (PIM, sometimes called processor in memory) which is the integration of a processor with RAM (random access memory) on a single IC. The result is sometimes known as a PIM chip or PIM IC.

The present disclosure includes apparatuses and methods for logic/memory devices. In one example embodiment, execution of logical operations is performed on one or more memory components and a logical component of a logic/memory device.

An example apparatus comprises a plurality of memory components adjacent to and coupled to one another. A logic component may in some embodiments be coupled to the plurality of memory components. At least one memory component comprises a partitioned portion having an array of memory cells and sensing circuitry coupled to the array. The sensing circuitry may include a sense amplifier and a compute component configured to perform operations. Peripheral circuitry may be coupled to the array and sensing circuitry to control operations for the sensing circuitry. The logic component may in some embodiments comprise control logic coupled to the peripheral circuitry. The control logic may be configured to execute instructions to perform operations with the sensing circuitry.

The logic component may comprise logic that is partitioned among a number of separate logic/memory devices (also referred to as “partitioned logic”) and which may be coupled to peripheral circuitry for a given logic/memory device. The partitioned logic on a logic component may include control logic that is configured to execute instructions configured for example to cause operations to be performed on one or more memory components. At least one memory component may include a portion having sensing circuitry associated with an array of memory cells. The array may be a dynamic random access memory (DRAM) array and the operations may include any logical operators in any combination, including but not limited to AND, OR, NOR, NOT, NAND, XOR and/or XNOR boolean operations.

In some embodiments, a logic/memory device allows input/output (I/O) channel and processing in memory (PIM) control over a bank or set of banks allowing logic to be partitioned to perform logical operations between a memory (e.g., dynamic random access memory (DRAM)) component and a logic component.

Through silicon vias (TSVs) may allow for additional signaling between a logic layer and a DRAM layer. Through silicon vias (TSVs) as the term is used herein is intended to include vias which are formed entirely through or partially through silicon and/or other single, composite and/or doped substrate materials other than silicon. Embodiments are not so limited. With enhanced signaling, a PIM operation may be partitioned between components, which may further facilitate integration with a logic component's processing resources, e.g., an embedded reduced instruction set computer (RISC) type processing resource and/or memory controller in a logic component.

Disclosed herein in one aspect is a PIM architecture that embeds new compute elements, which are referred to as neuron processing elements (NPE). In some examples, the PIM architecture may be referred to as Computing in DRAM with Artificial Neurons (CIDAN). The NPEs may in some embodiments be embedded in the DRAM chip but reside outside the DRAM array. CIDAN increases the computation capability of the memory without sacrificing its area, changing its access protocol, or violating any timing constraints. Each NPE consists of a small collection of artificial neurons (also known as threshold logic gates (S. Muroga. Threshold logic and its applications. Wiley-Interscience, 1971)) enhanced with local registers. One implementation of an artificial neuron as contemplated herein is a mixed-signal circuit that computes a set of threshold functions of its inputs. The specific threshold function is selected on each cycle by enabling or disabling each of the inputs associated with the artificial neuron (using a multiplexer connected to the artificial neuron) using control signals (connected to the control inputs of the multiplexer). This results in a negligible overhead for providing reconfigurability. In addition to the threshold functions, an NPE may be capable of realizing some non-threshold functions by a sequence of artificial neuron evaluations. Furthermore, artificial neurons consume substantially less energy and are significantly smaller than their CMOS equivalent implementations (Wagle et al., 2019 IEEE 37th International Conference on Computer Design (ICCD), page 550-558, November 2019). Due to the inherent advantages of an NPE in reconfigurability, small area footprint, and low energy consumption, the CIDAN platform disclosed herein is shown to achieve high throughput and energy efficiency for several operations and CNN architectures. Some key advantages of the systems and methods disclosed herein are listed below.

The disclosed device presents a novel integration of an artificial neuron processing element in a DRAM architecture to perform logic operations, arithmetic operations, relational operations, predication, and other complex operations under the timing and area constraints of the DRAM modules.

The disclosed design can process data with different element sizes (1-bit, 2-bits, 4-bits, 8-bits, 16-bits, 32-bits, or more) which are used in popular programming languages. This processing is enabled by using operand decomposition computing and scheduling algorithms for the NPE.

A case study on a CNN algorithm with optimized data-mapping on DRAM banks for improved throughput and energy efficiency under the limitations of existing DRAM access protocols and timing constraints is presented.

### DRAM: Architecture, Operation and Timing Parameters

This subsection includes a description of the architecture, operation, and timing specifications of a DRAM. For in-memory computation, these specifications are needed to ensure that the area and timing of the original DRAM architecture are preserved when computation is integrated.

The organization of DRAM, in some embodiments, is shown in FIG. 1. This organization comprises several levels of hierarchy. The lowest level of the hierarchy, which forms the building block of DRAM, is called a bank 105. A bank contains a 2D array of memory cells, a row of sense amplifiers 110, a row decoder 115, and a column decoder 120. A collection of banks is contained in a DRAM chip. Memory banks in a chip share the I/O ports and an output buffer, and hence, only one bank per chip can be accessed to read or write using a shared memory bus at a given time. DRAM chips may be arranged on a circuit board module called a dual-in-line memory module (DIMM). A DIMM has DRAM chips arranged on its two sides (front and back). Each side is called a rank and is connected to a chip select signal. The ranks use the memory channel in a lockstep manner, but they are independent and can operate in parallel. When data needs to be fetched from the DRAM, the CPU communicates with the DRAM over a memory channel with a data bus that may be 64 bits wide. Multiple DIMMs can share a memory channel. Hence, a multiplexer may be used to select the DIMM to provide data to the CPU. One rank of the DIMM provides data to fill the entire data bus. All the DRAM chips in a rank may operate simultaneously while reading or writing data. The memory hierarchy presented above is meant to activate several parts of the DRAM in parallel and fetch large quantities of data simultaneously from multiple banks in a single cycle. By extension, in-memory architectures use this hierarchy to perform operations on large segments of data in parallel.

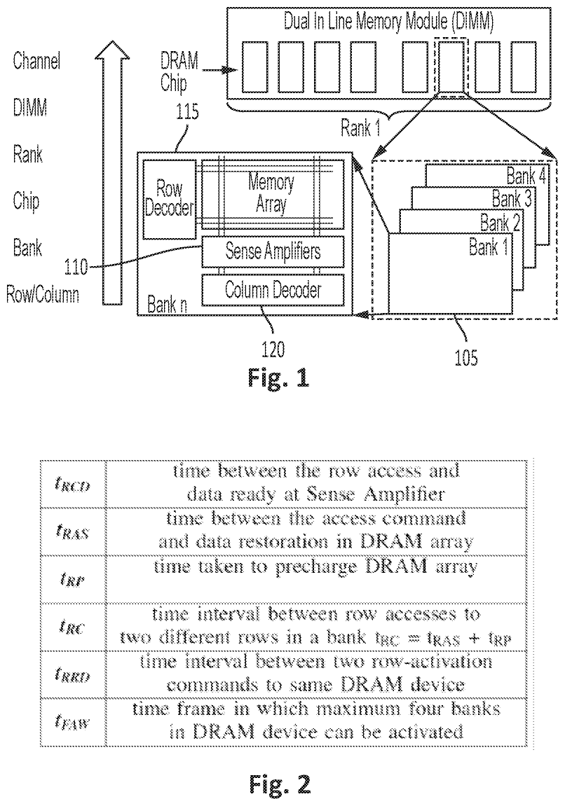

A DRAM memory controller may control the data transfers between the DRAM and the CPU. Therefore, almost all the currently available in-memory architectures (Angizi & Fan, 2019 IEEE/ACM International Conference on Computer-Aided Design (ICCAD), page 1-8, November 2019; Hajinazar et al., ASPLOS '21: 26th ACM International Conference on Architectural Support for Programming Languages and Operating Systems, page 329-345, April 2021; Seshadri et al., Proceedings of the 50th Annual IEEE/ACM International Symposium on Microarchitecture, page 273-287, October 2017; Li et al., Proceedings of the 50th Annual IEEE/ACM International Symposium on Microarchitecture, page 288-301, October 2017; Deng et al., 2018 55th ACM/ESDA/IEEE Design Automation Conference (DAC), page 1-6, June 2018) modify the technique used to access the data and extend the functionality of the memory controller to perform the logic operations. In one example, a controller issues a sequence of three commands to the DRAM: Activate (ACT), Read/Write (R/W), and precharge (PRE), along with the memory address. The ACT command copies a row of data into the sense amplifiers through the corresponding bitlines. Here, the array of sense amplifiers is called a row buffer as it holds the data until another row is activated in the bank. The READ/WRITE command reads/writes a subset of the row buffer to/from the data bus by using a column decoder. After the data is read or written, the PRE command charges the bitlines to their resting voltage VDD/2, so that the memory bank is ready for the next operation. After issuing a command, the DRAM controller has to wait for an adequate amount of time before it can issue the next command. Such restrictions imposed on the timing of issuing commands are known as timing constraints. Some definitions of timing parameters (Jacob et al, Memory systems: cache, DRAM, disk. Morgan Kaufmann Publishers, 2008) are listed in FIG. 2.

Due to the power budget, some DRAM architectures allow only four banks in a DRAM chip to stay activated simultaneously within a time frame of t_{FAW}. The DRAM controller can issue two consecutive ACT commands to different banks separated by a time period of t_{RRD}. As a reference, an exemplary 1Gb DDR3-1600 RAM has t_{RRD}=7.5 ns and t_{FAW}=30 ns (Chandrasekar et al., DRAMPower: Open-source DRAM Power and Energy Estimation Tool). In the detailed description below, the impact of these timing parameters on the delay in executing logic functions will be shown for the proposed processing-in-memory (PIM) architecture.

### Processing in Memory

PIM architectures are classified into two categories: mixed-signal PIM (mPIM) and digital PIM (dPIM) architectures. The dPIM architectures can be further classified as internal PIM (iPIM) and external PIM (ePIM). The differences between these architectures are described as follows.

mPIM architectures use memory crossbar-arrays to perform matrix-vector multiplication (MVM) and accumulation in the analog domain. These architectures then convert the result into a digital value using an analog to digital converter (ADC). Thus, mPIM architectures approximate the result, and accuracy depends on the precision of the ADC. A few representative works of mPIM are (Yin et al., IEEE Transactions on Very Large Scale Integration (VLSI) Systems, (1):48-61, January 2020; Chi et al., SIGARCH Comput. Archit. News, 44(3):27-39, October 2016; Guo et al., 2017 IEEE International Electron Devices Meeting (IEDM), pages 6.5.1-6.5.4, December 2017). mPIM architectures may be based on SRAMs or non-volatile memories. They may in some embodiments be used for machine learning applications to perform multiply and accumulate (MAC) operations.

In contrast to the mPIM architecture, iPIM architectures (Angizi & Fan, 2019 IEEE/ACM International Conference on Computer-Aided Design (ICCAD), page 1-8, November 2019; Hajinazar et al., ASPLOS '21: 26th ACM International Conference on Architectural Support for Programming Languages and Operating Systems, page 329-345, April 2021; Seshadri et al., Proceedings of the 50th Annual IEEE/ACM International Symposium on Microarchitecture, page 273-287, October 2017; Li et al., Proceedings of the 50th Annual IEEE/ACM International Symposium on Microarchitecture, page 288-301, October 2017; Deng et al., 2018 55th ACM/ESDA/IEEE Design Automation Conference (DAC), page 1-6, June 2018; Xin et al., 2020 IEEE International Symposium on High Performance Computer Architecture (HPCA), page 303 314. IEEE, February 2020) modify the structure of the DRAM cell, the row decoding logic and the sense amplifiers in such a way that each cell can perform a one-bit or two-bit logic operation. Thus, primitive logic operations can be carried out on an entire row (8 kB) in parallel. Logic operations on multi-bit operands may be performed in a bit-serial manner (Judd et al., 2016 49th Annual IEEE/ACM International Symposium on Microarchitecture (MICRO), page 1-12. IEEE, October 2016; Ali et al., IEEE Transactions on Circuits and Systems I: Regular Papers, 67(1):155-165, January 2020), which results in lower throughput for large bit-width operands, e.g., multiplication. These architectures generally achieve high energy efficiency on bit-wise operations as they operate directly on memory rows and process entire rows in parallel.

ePIM architectures embed digital logic outside the DRAM memory array, but on the same die. These architectures may in some embodiments work on a subset of the memory row and hence process fewer elements in parallel. The logic gates used in ePIM architectures are designed for multi-bit elements and implement a limited number of operations. Hence, they act as hardware accelerators with high throughput for specific applications. Recently, the DRAM makers SK-Hynix (He et al., 2020 53rd Annual IEEE/ACM International Symposium on Microarchitecture (MICRO), page 372-385, October 2020) and Samsung (Kwon et al., 2021 IEEE International Solid-State Circuits Conference (ISSCC), volume 64, page 350-352, February 2021) introduced 16-bit floating-point processing units inside the DRAM. ePIM architectures may in some embodiments have a high area overhead and, in some cases, necessitate reducing the size of memory arrays to accommodate the added digital logic.

For accelerating, multiplication, and other non-linear functions at higher bit-widths of 8 and 16 bits, certain look-up table architectures have also been proposed (Deng et al., 2019 56th ACM/IEEE Design Automation Conference (DAC), page 1-6, June 2019; Ferreira et al., CoRR, abs/2104.07699, 2021; Sutradhar et al., IEEE Transactions on Parallel and Distributed Systems, 33(2):263-275, February 2022). These architectures store small lookup tables in DRAM for implementing complex exponential and non-linear functions in a single clock cycle.

Though existing PIM architectures can deliver much higher throughput as compared to traditional CPU/GPU architectures (Angizi & Fan, 2019 IEEE/ACM International Conference on Computer-Aided Design (ICCAD), page 1-8, November 2019), their disadvantages include loss of precision (mPIM architectures), low energy efficiency and high area overhead (ePIM architectures), and low throughput on complex operations (iPIM architectures).

Work on Logic Operations (iPIM) and Arithmetic Operations (ePIM) in DRAM

Currently available iPIM architectures such as AMBIT (Seshadri et al., Proceedings of the 50th Annual IEEE/ACM International Symposium on Microarchitecture, page 273-287, October 2017), ReDRAM (Angizi & Fan, 2019 IEEE/ACM International Conference on Computer-Aided Design (ICCAD), page 1-8, November 2019), DRISA (Li et al., Proceedings of the 50th Annual IEEE/ACM International Symposium on Microarchitecture, page 288-301, October 2017), DrAcc (Deng et al., 2018 55th ACM/ESDA/IEEE Design Automation Conference (DAC), page 1-6, June 2018) and SIMDRAM (Hajinazar et al., ASPLOS '21: 26th ACM International Conference on Architectural Support for Programming Languages and Operating Systems, page 329-345, April 2021) extend the operations of a standard DRAM to perform logic operations.

In the case of ReDRAM, two rows are activated (double row activation (DRA)) simultaneously and they undergo the same charge sharing phase with the BL as in the case of AMBIT. To prevent the loss of original data at the end of TRA or DRA, both AMBIT and ReDRAM reserve some rows (referred to as “compute rows”) in the memory array to exclusively perform a logic operation. Hence, for every operation, the operands are copied from the source rows to the compute rows by using the copying operation described in (Seshadri et al., Proceedings of the 46th Annual IEEE/ACM International Symposium on Microarchitecture—MICRO-46, page 185-197, 2013). A copy operation is carried out by a command sequence of ACT→ACT→PRE which takes 82.5 ns in 1 Gb DDR3-1600. In AMBIT, all the 2-input operations such as AND, OR etc. are represented using a 3-input majority function.

ReDRAM improves upon the work of AMBIT by reducing the number of rows that need to be activated simultaneously to two. After the charge sharing phase between two rows, a modified sense amplifier is used to perform the logic operation and write back the result.

TABLE I
Comparison of CIDAN with iPIM and ePIM architectures.

| | CIDAN | IPIM | ePIM |
|---|---|---|---|
| Operation | Digital | Analog | Digital |
| Reliability | High | Low | High |
| Area | Low | Low | High |
| Parallelism | High | High | Low |
| Application Specific | No | No | Yes |
| Multi-bit precision performance | High | Low | High |

ReDRAM, AMBIT, and the related designs DRISA, DrAcc and SIMDRAM, have a complete set of basic functions and can exploit full internal bank data width with a minimum area overhead. However, their shortcomings include:

These designs rely on sharing charges between the storage capacitors and bitlines for their operation. Due to the analog nature of the operation, the reliability of the operation can be affected under varying operating conditions.

ReDRAM modifies the inverters in the sense amplifier to shift their switching points using transistors of varying threshold voltage at design time. Hence, such a structure is also vulnerable to process variations.

All these designs overwrite the source operands, because of which rows need to be copied before performing the logic operations. Such an operation reduces the overall throughput that can be achieved when performing logic operations on bulk data.

Existing iPIM architectures perform bitwise operations which result in significant latency and energy consumption for multi-bit (4-bits, 8-bits, 16-bits, etc.) operands. Hence, their throughput and energy benefits show a decreasing trend for higher bit precision. To overcome this shortcoming, the architectures with custom logic (large multipliers and accumulators) (He et al., 2020 53rd Annual IEEE/ACM International Symposium on Microarchitecture (MICRO), page 372-385, October 2020), programmable computing units (Kwon et al., 2021 IEEE International Solid-State Circuits Conference (ISSCC), volume 64, page 350-352, February 2021), and LUT-based designs LAcc (Deng et al., 2019 56th ACM/IEEE Design Automation Conference (DAC), page 1-6, June 2019), pPIM (Sutradhar et al., IEEE Transactions on Parallel and Distributed Systems, 33(2):263-275, February 2022), pLUTo (Ferreira et al., CoRR, abs/2104.07699, 2021) have been proposed. These architectures embed external logic to the DRAM outside the memory array, and hence may be referred to as ePIM architectures. Such architectures are amenable to specific applications and act as hardware accelerators for them. ePIM architectures have a huge area overhead and consequently may sacrifice the DRAM storage capacity.

CIDAN is designed to overcome the shortcomings of the discussed literature and provide flexibility to perform data-intensive applications with multi-bit operands. A comparison of CIDAN with iPIM and ePIM architectures is shown in Table I above.

Key Advantages of CIDAN: The disclosed platform, CIDAN, improves the existing iPIM and ePIM architectures in seven distinct ways.

1) Neither the memory bank nor its access protocol is modified.

2) There is no need for special sense amplifiers for its operation.

3) The NPEs are DRAM fabrication process compatible and have a small area footprint.

4) There is no reduction in DRAM capacity, when the NPEs are implemented on a DRAM chip on which, e.g., 20% of the silicon area is reserved for compute logic.

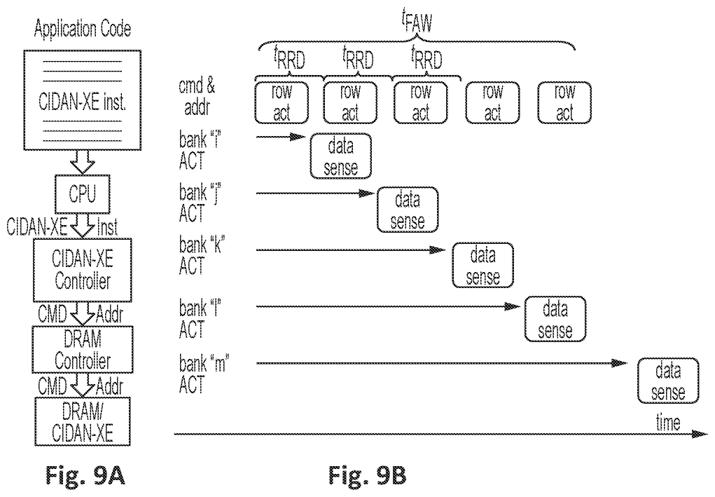

5) CIDAN adheres to the existing DRAM constraint of having a maximum of four active banks, as illustrated, for example, in FIG. 9B.

6) The NPEs connected to the DRAM do not rely on charge sharing over multiple rows and are essentially static logic circuits.

7) The NPEs are reconfigured at run-time using control bits to realize different functions and the cost of reconfiguration is negligible compared to lookup table (LUT)-based designs.

### Threshold Logic Function and Artificial Neurons

A Boolean function ƒ (x1, x2, . . . , xn) is called a threshold function if there exist weights wᵢ for i=1, 2, . . . , n and a threshold T such that

ƒ(x1,x2, . . . xn)=1⇔Σᵢ₌₁ⁿwᵢxᵢ≥T Equation 1

where Σ denotes the arithmetic sum, and where, without loss of generality, the wᵢ and T may be integers. Thus a threshold function can be represented as (W, T)=[w1,w2, . . . , wn; T]. An example of a threshold function is ƒ(a, b, c, d)=ab ∨ac ∨ad ∨bcd, with [w1,w2,w3,w4; T]=[2, 1, 1, 1; 3]. An extensive body of work exploring many theoretical and practical aspects of threshold logic can be found in (S. Muroga. Threshold logic and its applications. Wiley-Interscience, 1971). In the following, a threshold logic gate is referred to as an artificial neuron (AN) to avoid confusion with the notion of a threshold voltage of a transistor, which is also used in the design of the neuron.

Several implementations of ANs already exist in the literature (Wagle et al., 2019 IEEE 37th International Conference on Computer Design (ICCD), page 550-558, November 2019; Yang et al., 2014 IEEE/ACM International Symposium on Nanoscale Architectures (NANOARCH), pages 39-44. IEEE, July 2014; Vrudhula et al., 2015 IEEE International Symposium on Circuits and Systems (ISCAS), pages 373-376. IEEE, May 2015; Kulkarni et al., IEEE Transactions on Very Large Scale Integration (VLSI) Systems, 24(9):2873-2886, September 2016) and have been successfully integrated and fabricated in ASICs (Yang et al., 2015 IEEE Custom Integrated Circuits Conference (CICC), pages 1-4. IEEE, September 2015). Gates in such implementations evaluate Equation 1 by directly comparing some electrical quantity such as charge, voltage, or current. In the present disclosure, a variant of the architecture shown in (Wagle et al., 2019 IEEE 37th International Conference on Computer Design (ICCD), page 550-558, November 2019) is used, as it is the AN available at the smallest technology node (40 nm).

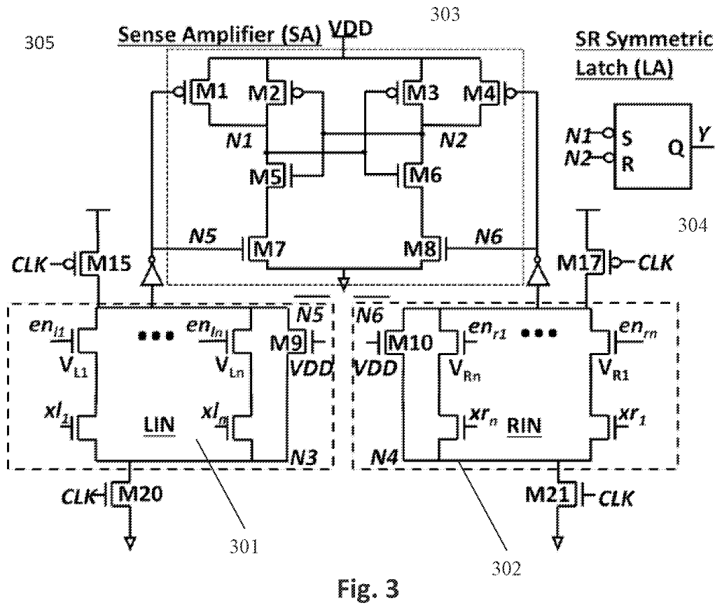

FIG. 3 shows the circuit diagram of the AN. It consists of four components: left and right input networks (301 and 302 respectively), a sense amplifier 303, and a latch 304. When the clock signal is 0, N̅5̅ and N̅6̅ rise to 1 through transistor M15. This resets the sense amplifier through transistors M1 and M4 (N1=N2=1). For evaluation, appropriate input signals are provided to inputs xl₁ to xlₙ and xr₁ to xrₙ, which in turn allow current to pass through the branches of LIN and RIN respectively. The current passing through the branches is proportional to the widths and threshold voltages of the flash transistors VL₁ to VLn and VR₁ to VRₙ, which in turn serve as a proxy for the weights of the threshold function. Additional enable signals enn to en₁ₙ and enᵣ₁ to enᵣₙ have been incorporated to select branches corresponding to the inputs that are being evaluated. During an evaluation phase, both the LIN and RIN discharge N̅5̅ and N̅6̅. Without loss of generality, assuming N̅5̅ discharges faster than N̅6̅, M7 turns on before M8, which enables the discharge of N1 faster than N2. N1 shuts off the transistor M6 and chokes the discharge path of N2. In the end, N1 is at 0 and N2 is at 1. The SR latch uses the differential output of the sense amplifier and evaluates to 1. Since the sense amplifier compares the conductivity of LIN and RIN, it serves as a proxy for the inequality shown in Equation 1. LIN represents the left side of the equation and RIN represents the right side. Ensuring that the inputs to LIN and RIN are applied at a clock edge turns the circuit into a multi-input, edge-triggered flipflop, that computes the Boolean threshold function. Transistors M9 and M10 prevent the N̅5̅ and N̅6̅ from any potential floating condition in case all the branches are turned off. FIG. 3 shows a circuit for an artificial neuron in some embodiments. In other embodiments, an artificial neuron may be constructed differently. As used herein, an “artificial neuron” (or “artificial neuron circuit”) is any circuit having a plurality of inputs and an output, the signal at the output being based on a weighted sum of the signals at the inputs.

### Neuron Processing Element (NPE)

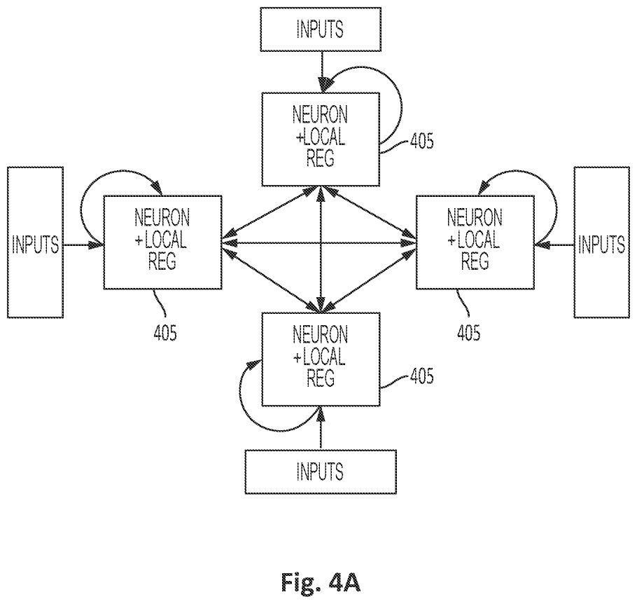

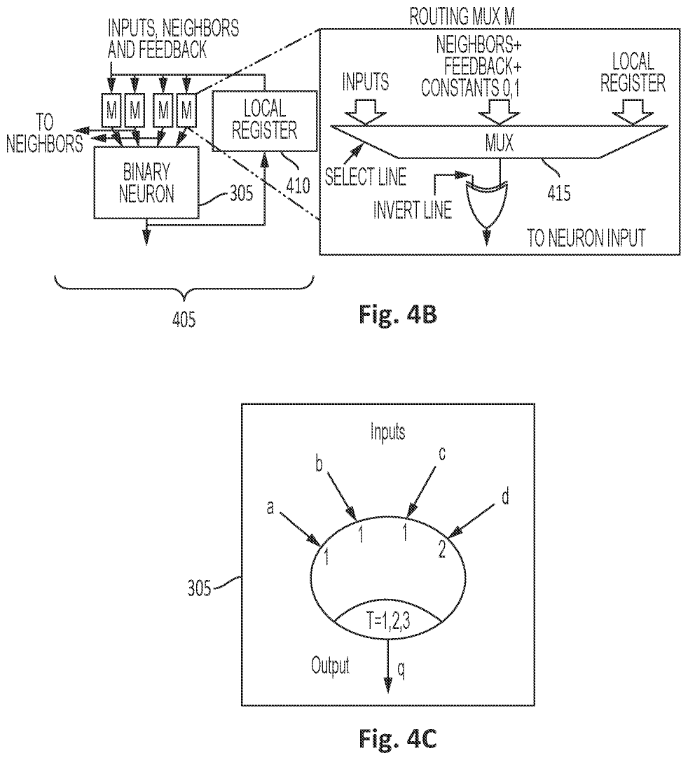

The processing element disclosed herein is based on the design described in (Wagle et al., 2020 IEEE 38th International Conference on Computer Design (ICCD), page 433-440. IEEE, October 2020). It is used to operate on multi-bit data and is sometimes referred to herein as a Neuron Processing Element (NPE). The architecture of the NPE is shown in FIG. 4A. The depicted NPE comprises K (=4) fully connected ANs, denoted by AN k, where k is the index of the neuron. Each AN is part of a circuit element, which may be referred to as a configurable processing circuit 405, and which includes the AN 305, a 16-bit local register 410, and a plurality of multiplexers 415, each of the multiplexers 415 having (i) a plurality of data inputs and (ii) an output connected to a respective input of the AN 305, as shown in FIG. 4B. The neurons may communicate with each other using the multiplexers 415. The combination of an AN 305 and a set of multiplexers operates as a controllable AN the threshold function of which can be changed by changing the control inputs (or “select lines”) of the multiplexers 415. As used herein, a “controllable AN” is an AN the threshold function of which can be changed by changing control signals fed to the AN (e.g., the control signals may set the select lines of the multiplexers). Each AN has I (=4) inputs, denoted as x_{i,k}, where i is the index of the input of AN k. The output of AN k at time t is denoted as q_{k,t}. These ANs implement the threshold function [2, 1, 1, 1; T] such that T is a value selected from [1, 2, 3]. The threshold value (T) is assigned during run time using digital control signals (e.g., by setting to 1 one of a plurality of RIN inputs, the input selected to be one that has the desired weight). An NPE can perform bitwise logical operations such as (N)AND, (N)OR, NOT, and 3-input majority in a single clock cycle using a single neuron inside it. It is to be noted that, since each neuron in the NPE can process NOT and a majority function, CIDAN can support all the functions as described in (Hajinazar et al., ASPLOS '21: 26th ACM International Conference on Architectural Support for Programming Languages and Operating Systems, page 329-345, April 2021) by using majority inverter graph conversion. An NPE can also process 4-bit operands in parallel where it includes four ANs. Single or multi-bit addition, comparison, pooling, and ReLU operations can be scheduled on the NPE as described in (Wagle et al., 2020 IEEE 38th International Conference on Computer Design (ICCD), page 433-440. IEEE, October 2020). Wagle et al. used the NPE to implement binary neural networks (BNNs) with activation and weights being single bit values. In the present disclosure, the NPE is extended to enable multi-bit operations (e.g., multi-bit neural network operations) such as multiplication, accumulation, pooling, and various activation functions. An NPE may consume, on average, substantially lower power (e.g., 59 times lower power), and have an area that is substantially smaller (e.g., 23 times smaller) than a functionally equivalent CMOS standard cell implementation. As such, even though the NPE may be slower than a CMOS standard cell implementation, a solution using NPEs may significantly outperform a solution based on CMOS standard cells, in a design that is limited by area or power. A set of NPEs may be capable of operating in a single instruction multiple data (SIMD) mode, or of performing multiple operations simultaneously on a single piece of data.

TABLE II
Inputs and threshold selection for various bitwise operation
on a single AN. IP1, IP2 and IP3 are input operand bits.

| Operation | a | b | c | d | T |
|---|---|---|---|---|---|
| NOT (a) | IP1 | 0 | 0 | 0 | 1 |
| AND (a, b) | IP1 | IP2 | 0 | 0 | 2 |
| OR (a, b) | IP1 | IP2 | 0 | 0 | 1 |
| MAJ (a, b, c) | IP1 | IP2 | IP3 | 0 | 2 |

### Basic Logic Operation on an AN

ANs in the NPE implement the threshold function [2, 1, 1, 1; T] which can be reconfigured to perform logic operations on binary operands just by enabling or disabling the required inputs and choosing the appropriate threshold value (7). Each combination of an AN and a set of input multiplexers acts as a reconfigurable static gate where the cost of reconfiguration is just the choice of the appropriate inputs and the selection of the threshold value (7). This low reconfiguration cost of the basic elements of the NPE reduces the overall area and power cost of the processing element. In the AN structure as shown in FIG. 4C, for example, the binary inputs are a, b, c, and d and the output is y. Table II above shows the enabled inputs and the threshold values for different bitwise operations on a single AN. 1 bit-addition using XOR and the majority operation scheduled on two ANs are described in more detail below.

### Multi-Bit Addition and Accumulation Operation

Two m-bit numbers X=xₘ₋₁, xₘ₋₂, . . . x₁, x₀ and Y=yₘ₋₁, yₘ₋₂, . . . y₁, y₀ can be added by mapping a chain of neuron-based ripple carry adders on the NPE. The final sum S=X+Y={Cₘ₋₁, Sₘ₋₁, Sₘ₋₂, . . . S₁, S₀} is generated as follows:

Cycles indexed 0 to m−1 are used to generate the carry bits by mapping the compute of the carry function to the third AN of the NPE. Here, the carry function is the majority operation of two input bits xᵢ, yᵢ and the previous carry

Cₜ=q_{3,t+1}={xₜ+yₜ+q_{3,t}≥2} Equation 2

Cycles indexed 1 to m are used to generate the sum bits, by mapping the compute of sum function to the second AN of the NPE:

Sₜ₋₁=q_{2,t+1}={xₜ₋₁+yₜ₋₁+q_{3,t-1}−2q_{3,t}≥1} Equation 3

The value q_{3,t-1} is supplied to the sum function at time t by using AN 4 as a buffer.

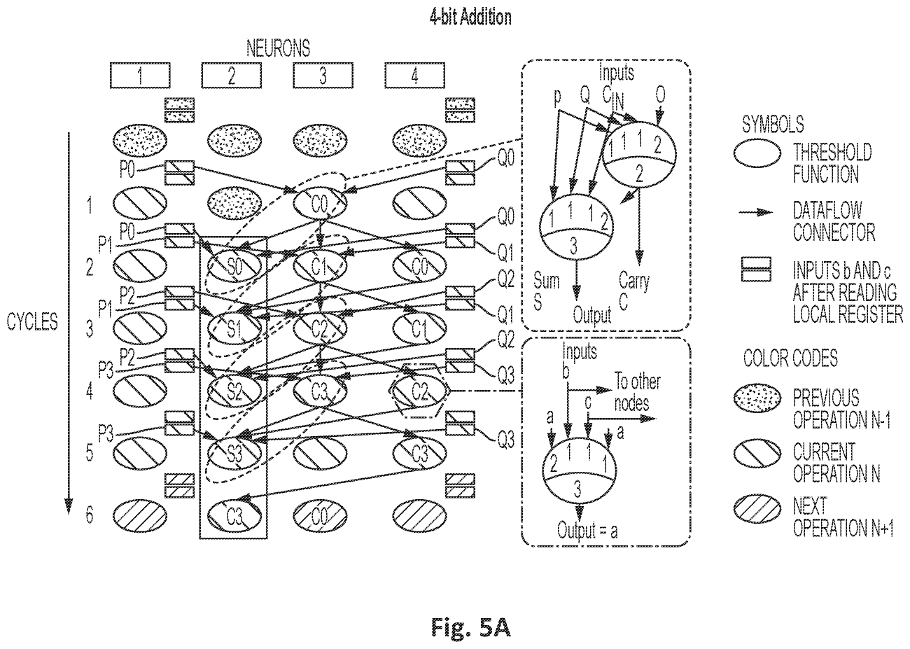

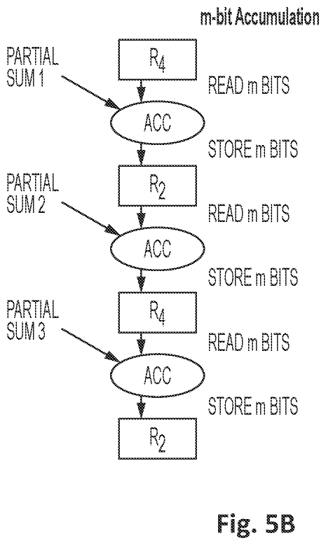

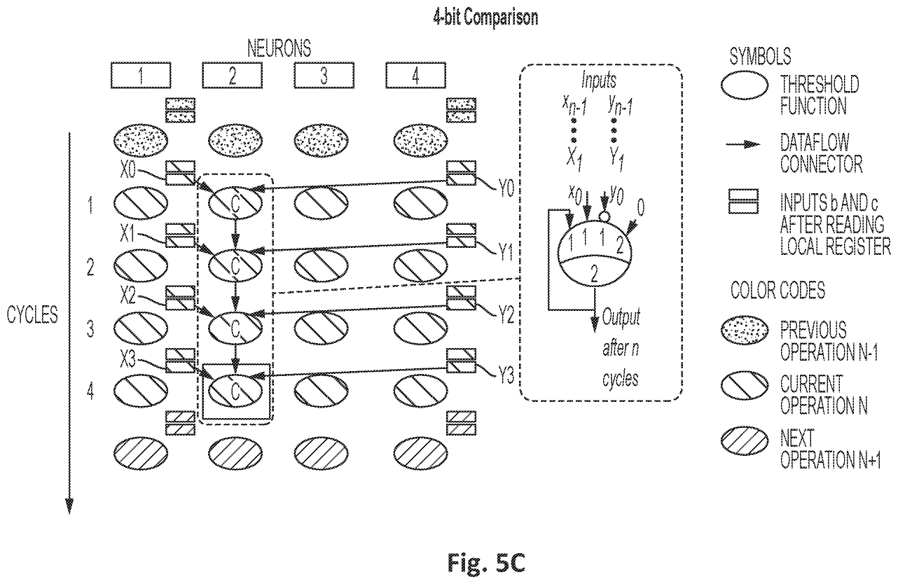

The above mapping is illustrated in FIG. 5A. The bits corresponding to X and Y are fetched from the DRAM in one cycle and are stored in the local registers. ANs 1 and 2 then fetch the required bits from the local registers on a cycle-by-cycle basis to do the evaluation. Unused inputs of the ANs are connected to 0.

An accumulation operation of size M is treated as repeated addition of an m-bit number with the accumulated M bit number. In one embodiment, a disclosed NPE supports a maximum 32-bit accumulation operation. An accumulation schedule on NPE is shown in FIG. 5B.

### Multi-Bit Comparison and ReLU

Two m-bit numbers X=xₘ₋₁, xₘ₋₂, x₀ and Y=yₘ₋₁, yₘ₋₂, . . . y₁, y₀ can be compared (X>Y) in m cycles on the NPE as follows:

q_{1,t+1}={xₜ−yₜ+q_{1,t}≥1} Equation 4

The result of X>Y is q_{l,m}. Intuitively, in each cycle, the AN overrides the comparison result that was generated by all the previous lower significance bits if the value of a higher significance bit of X is greater than the value of the respective higher significance bit of Y. As an example, a schedule of a 4-bit comparison is shown in FIG. 5C.

The ReLU operation, commonly used in neural networks, is an extension of the comparison operation. It involves the comparison of an operand against a fixed value. The output of ReLU is the operand itself if it is greater than the fixed value, else the output is 0. This is realized by performing an AND operation of the result of the comparison with the input operand.

### Multi-Bit Multiplication

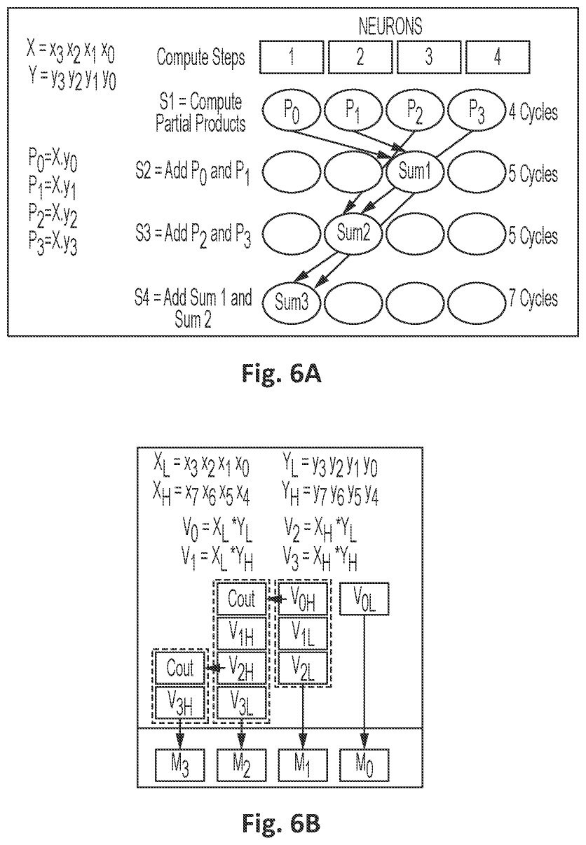

An NPE may in some embodiments act as a primitive unit for 4-bit multiplication. A multiplication operation may in some embodiments be broken into a series of bitwise AND and addition operations scheduled on an NPE. A schedule of 4-bit multiplication of two operands X={x3,x2,x1,x0} and Y={y3,y2,y1,y0} on NPE is shown in the FIG. 6A. The multiplication is completed in four steps. First, the partial products P0, P1, P2, P3 are obtained using four bitwise AND operations on all the ANs in parallel. This step is completed in 4 cycles. Next, the addition of P0 and 1-bit shifted version of P1 (Sum 1) is calculated in 5 clock cycles using the multi-bit addition schedule as discussed above. The result Sum1 is stored in the AN N3. Similarly, in the next step, P2 and a 1-bit shifted version of P3 are added in 5 cycles again with the result (Sum2) stored in the AN N2. In the last step, Sum1 and Sum2 stored in the ANs, N2 and N3 are added in 7 clock cycles as the Sum2 is shifted by 2 bits before addition. The final result of the multiplication (Sum3) is stored in the AN NI. In total, it takes 21 clock cycles to perform a 4-bit multiplication in a single NPE using the exemplary method illustrated in FIG. 6A.

For 8-bit operands, the multiplication is broken into smaller multiplication operations that use 4-bit operands, and a final addition schedule is used as shown in FIG. 6B. The operands X and Y are decomposed into 4-bit segments as X_{H}, X_{L}, and Y_{H}, Y_{L}, where the subscripts L and H represent the lower and the upper four bits of the 8-bit operand. The partial products of the 4-bit segments is represented as: V₀=X_{L}*Y_{L}, V₁=X_{H}*Y_{L}, V₂=X_{L}*Y_{H}, V3=X_{H}*Y_{H} and executed as 4-bit multiplications on the NPE. After the partial products are obtained, a series of addition operations are carried out as shown in FIG. 6B to obtain the final 16-bit result A. For operands of bit width 16, 32, 64, etc., multiplication can be carried out by recursively breaking up the operands into 4-bit segments and scheduling the operations on the NPE.

### Maxpooling and Average Pooling

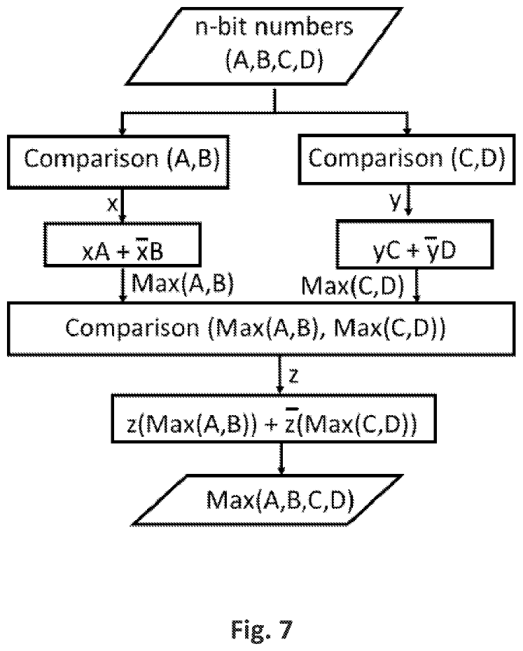

The max-pooling operation finds the maximum number in a set defined by the max-pooling window of a neural network. A max-pooling operation is carried out by a series of comparisons, bitwise AND, and bitwise OR operations. For illustration, let a max-pooling operation be applied to four n-bit numbers A, B, C, and D. In this case, the pooling window is 2×2. The max-pooling operations are illustrated in FIG. 7. Bits x, y, and z are binary results of the comparison of different inputs. The result of the max operation after the comparison is obtained using bitwise AND and OR operation of inputs with the comparison result bit is shown in FIG. 7. The maxpooling operation involves m−1 comparison operations for a set of m numbers.

Average pooling is supported for limited pooling windows which have a size in powers of 2, e.g. 2×2, 4×4, 8×8, etc. All the numbers in the set are added and then the right shift operation is used to realize division.

### Top-Level Architecture

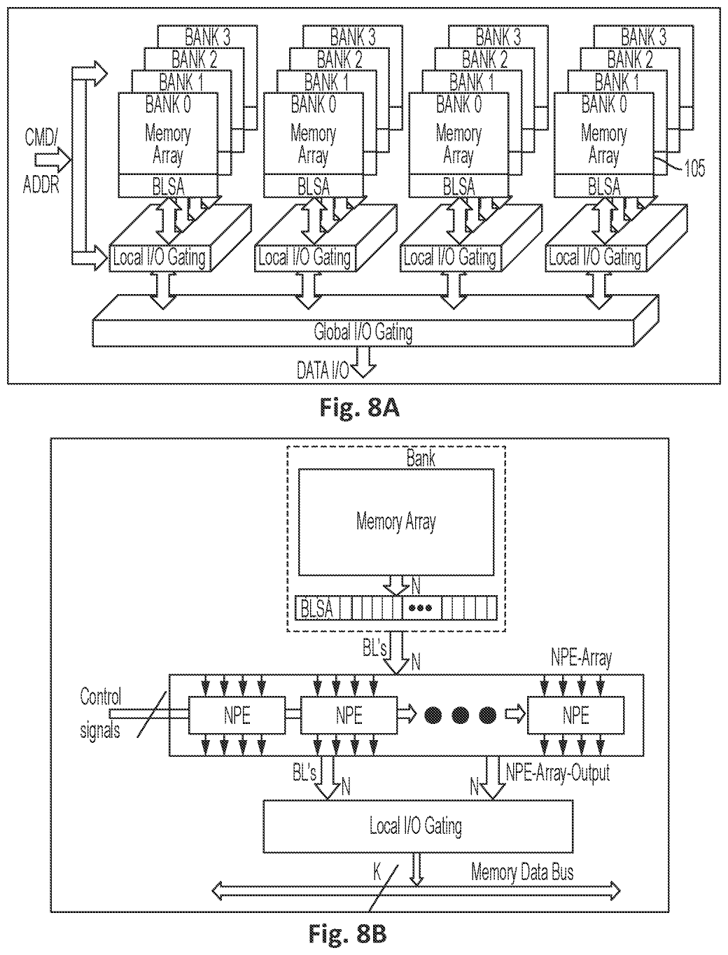

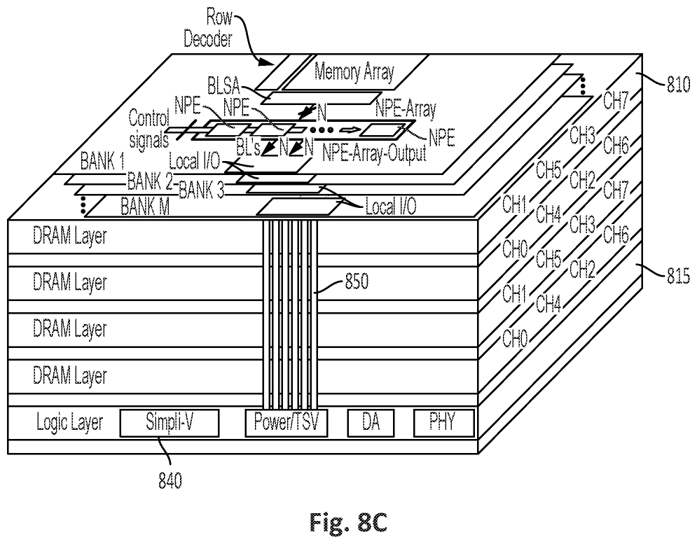

FIG. 8A shows a logical organization of banks in a DRAM. A group of banks shares local I/O gating which comprises column multiplexers and write drivers, and therefore only one bank at a time can be accessed for reading or writing by an external compute unit. However, it is possible to activate multiple banks within a group such that the data of a row can be latched to the local bitline sense amplifiers (BLSA). The number of banks that can be simultaneously activated is constrained by the power budget of the DRAM chip. This power constraint is enforced by the timing parameter t_{FAW}, which defines the time frame within which a maximum of four banks can be activated. Hence, within t_{FAW} data from four different banks can be latched into the BLSA and potentially can be used to perform operations. In CIDAN, the NPEs are placed between the BLSA and the local I/O gating to directly connect to the BLSA output as shown in FIG. 8B.

FIG. 8C shows a three-dimensional (3D) memory, such as a high-bandwidth memory. The 3D memory includes a plurality of DRAM layers 810 and a logic layer 815. Each DRAM layer 810 may include a memory array 830 and a plurality of NPEs, and the logic layer 815 may include a processor 840 (e.g., a Simpli-V) processor. Such a processor 840 (e.g., a Simpli-V processor) may be capable of performing floating point operations, of generating addresses for data access, and of controlling data movement inside the DRAM. Such capabilities may be ones which are not readily implemented in the NPEs. In FIG. 8C, a DRAM layer is a collection of banks organized into multiple channels. Banks and channels are logical hierarchy terms. Within each bank an array of NPEs is connected to the memory array by interfacing with an array of bit-line sense amplifiers (BLSA). A Simpli-V processor 840 is a custom implementation of an open source RISC-V processor. In the logic layer of the 3D memory, multiple Simpli-V cores or “processors” may be added. Each Simpli-V processor 840 may perform 32-bit or 64-bit general purpose integer or floating-point operations as specified by the instruction set of the Simpli-V processor 840. Data may be supplied to the Simpli-V processors 840 using through-silicon-vias (TSVs) 850 connecting the DRAM layers 810 and logic layer 815. Using Simpli-V processors 840 along with the NPEs enables the 3D memory to execute all the classes of data-intensive applications with high energy efficiency and high throughput.

In the depicted embodiment, an NPE is connected to four BLSA outputs. In other embodiments, an NPE having a different configuration may be connected to fewer or more than four BLSA outputs, for example two, six, eight, sixteen, thirty-two or more BLSA outputs. In the architecture depicted in FIG. 8B, if a row buffer has N bits, there are N/4 NPEs connected to the bank. As the depicted CIDAN works on four banks in parallel, there are a total of NNPEs in the DRAM. In some embodiments, if there are more than four banks in the DRAM, for example, 8 or 16, the NPEs are shared among all the banks using multiplexers but the number of NPEs stays constant to utilize only four banks in parallel. An NPE-array works on the operands derived from the same bank using sequential row activation commands. All the NPEs perform the same operation and share the control signals (which may be referred to as “instructions”) generated by an external controller. Once the operands are obtained in the NPEs, all the active banks can be pre-charged together. The latency of pre-charging the banks is overlapped with the compute latency of NPEs. An NPE can write the results back to the same bank by driving all the bit-lines connected to it through BLSA, or may in some embodiments write the results back to a different bank. In some embodiments, to write data to another bank, a local shared buffer among different banks is used. Writing an entire row-wide data to another bank in this way is a slower operation than writing back to the bank itself because of the limited capacity of the shared buffer. In some embodiments, there are eight rows reserved per bank to write the output data generated from the NPE-array.

### System Level Integration of CIDAN

CIDAN may be used as a memory and as an external accelerator that is interfaced with the CPU. The design of CIDAN includes the addition of some special instructions to the CPU's instruction set that specify the data and the operation to be carried out in the CIDAN. There are unused opcodes in most CPU instruction sets which can be re-purposed to define the instructions for CIDAN. A block diagram representing a system-level integration of CIDAN is shown in FIG. 9A. An application is modified to include the CIDAN instructions to replace the code which can be executed on the CIDAN platform in parallel. Whenever the CPU identifies CIDAN-specific instruction in the application, it passes it to the CIDAN controller—a state machine that decodes the instruction and generates DRAM commands and control signals to implement the specified operation by the instruction on CIDAN. Extra bits are added to the CPU-memory bus to accommodate the control signals from the CIDAN controller. In some embodiments, a compiler may be configured to recognize instructions or sets of instructions which would benefit from execution in a CIDAN architecture, and may include instructions configured to create appropriate machine code to perform the CIDAN instructions using the opcodes set aside for CIDAN.

Some embodiments of CIDAN use a maximum of four banks in parallel, and in such embodiments, the operands are pre-arranged across the banks for a row address before moving on to the next row. For every operation, to transfer the operand to the NPEs, the activation command for a row is generated sequentially separated by a time interval equal to t_{RRD}. The operand data is latched to local registers of the NPE from the BLSA. The activation commands are followed by a single precharge command which precharges all the active banks. The same set of commands is issued to get more operands or more bits of the operands if the operand bit width is greater than four. After the operands are obtained, the NPE operates and then writes back the data to the reserved rows for the output in the same bank itself or to another bank using the shared internal buffer. An operation sequence on a single bank of DRAM to obtain two operands on the connected NPE, perform an operation, and write back the result is shown in Equation 5 below. The compute operation on the NPE may be selected using control signals from the CIDAN controller. It should be noted that in the operation of CIDAN, no existing protocol or timing constraints of the DRAM are violated even when operating multiple banks in parallel. Therefore, no changes to the row decoder or memory controller are required to facilitate complex DRAM operations as may be done in some related work (Hajinazar et al., ASPLOS '21: 26th ACM International Conference on Architectural Support for Programming Languages and Operating Systems, page 329-345, April 2021; Seshadri et al., Proceedings of the 50th Annual IEEE/ACM International Symposium on Microarchitecture, page 273-287, October 2017; Li et al., Proceedings of the 50th Annual IEEE/ACM International Symposium on Microarchitecture, page 288-301, October 2017; Deng et al., 2018 55th ACM/ESDA/IEEE Design Automation Conference (DAC), page 1-6, June 2018).

ACT→PRE→ACT→PRE→(Compute on NPE)→WR Equation 5

In some embodiments, the NPEs may be interfaced with banks of any type of main memory architecture including 2D or 3D architectures of DRAM technology or any other technology which might replace DRAM in the future as the main memory in general-purpose computing systems.

The processing in memory (PIM) design of some embodiments may support different classes of data-intensive operations with bit-wise Boolean operations, arithmetic and logic operations on a quantized bit-width (<16 bits) and operations on 32-bit or 64-bit integers or floating-point (FP) operations.

Table III shows various applications that may be supported by the combination of NPEs in the memory with one or more processors (also in the memory, as in the embodiment of FIG. 8C, for example).

TABLE III

| Applications | | Operations | Hardware |
|---|---|---|---|
| Graph Neural Networks, | → | 32-Integer, FP General | Use Simpli-V cores |
| Recommendation Systems | | Operations, Data Movement | |
| Machine Learning | → | 16-bit Integer/FP Specific | NPEs only |
| (DNNs/QNNs) | | Operations | |
| Database, Encryption, | → | Bitwise Boolean Operations | NPEs only |
| Genome Analysis | | on Large Bit-Vectors | |

In some embodiments, a single architecture, as disclosed herein, may support multiple applications. Although some embodiments disclosed herein use (two-dimensional) DRAM (e.g., dual in line modules (DIMMs)) as the memory that is connected to the NPEs, the present disclosure is not limited to such embodiments, and any other suitable type of memory may be used instead of two-dimensional DRAM, such as HBM, hybrid memory cube (HMC), or other memory architectures (e.g., ones that, unlike DRAM, are not based on capacitor storage elements). In some embodiments the memory is persistent memory instead of being volatile memory. Although some applications disclosed herein are neural networks (e.g., convolutional neural networks or quantized neural networks), the present disclosure is not limited to such embodiments, and general purpose processing in memory applications may be implemented using embodiments disclosed herein.

### Computing System

In some aspects of some embodiments of the present invention, software executing the instructions provided herein may be stored on a non-transitory computer-readable medium, wherein the software performs some or all of the steps of some aspects of some embodiments of the present invention when executed on a processor.

Aspects of some embodiments of the invention relate to algorithms executed in computer software. Though certain embodiments may be described as written in particular programming languages, or executed on particular operating systems or computing platforms, it is understood that the system and method of some embodiments of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of some embodiments of the present invention may be executed on any acceptable computing platform, including but not limited to a server, a cloud instance, a workstation, a thin client, a mobile device, an embedded microcontroller, a television, or any other suitable computing device known in the art.

Parts of some embodiments of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of some embodiments of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of some embodiments of this invention are described as communicating over a variety of wireless or wired computer networks. For the purposes of some embodiments of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of some embodiments of the invention may be implemented over a Virtual Private Network (VPN).

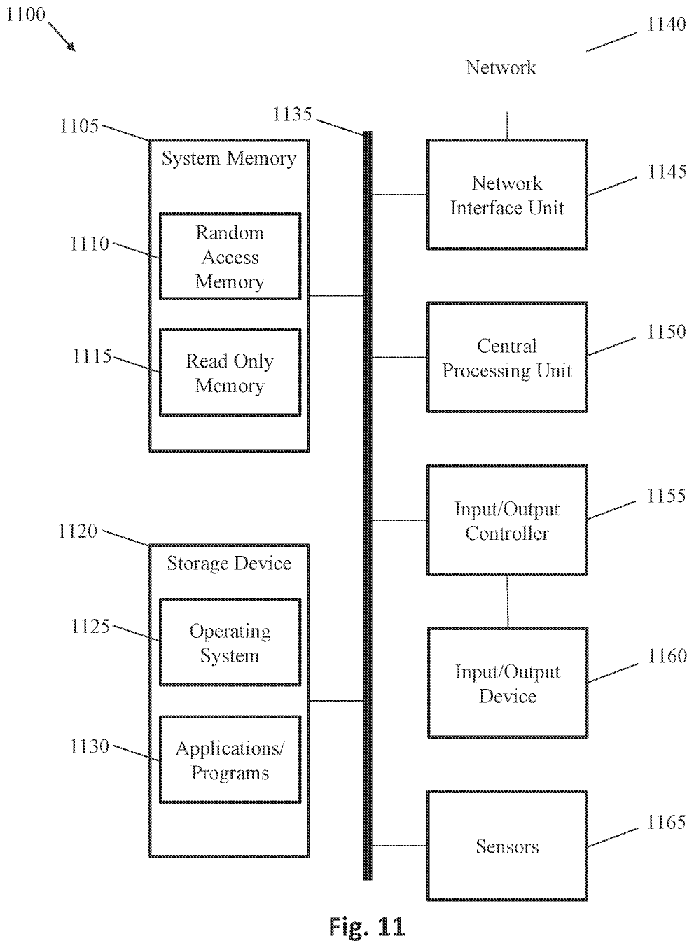

FIG. 11 and the following discussion are intended to provide a brief, general description of a suitable computing environment in which some embodiments of the invention may be implemented. While some embodiments of the invention is described above in the general context of program modules that execute in conjunction with an application program that runs on an operating system on a computer, those skilled in the art will recognize that some embodiments of the invention may also be implemented in combination with other program modules.

Generally, program modules include routines, programs, components, data structures, and other types of structures that perform particular tasks or implement particular abstract data types. Moreover, those skilled in the art will appreciate that some embodiments of the invention may be practiced with other computer system configurations, including hand-held devices, multiprocessor systems, microprocessor-based or programmable consumer electronics, minicomputers, mainframe computers, and the like. Some embodiments of the invention may also be practiced in distributed computing environments where tasks are performed by remote processing devices that are linked through a communications network. In a distributed computing environment, program modules may be located in both local and remote memory storage devices.

FIG. 11 depicts an illustrative computer architecture for a computer 1100 for practicing the various embodiments of the invention. The computer architecture shown in FIG. 11 illustrates a conventional personal computer, including a central processing unit 1150 (“CPU”), a system memory 1105, including a random access memory 1110 (“RAM”) and a read-only memory (“ROM”) 1115, and a system bus 1135 that couples the system memory 1105 to the CPU 1150. In some embodiments, a plurality of NPEs may be integrated with the RAM 1110, for example. A basic input/output system containing the basic routines that help to transfer information between elements within the computer, such as during startup, is stored in the ROM 1115. The computer 1100 further includes a storage device 1120 for storing an operating system 1125, application/program 1130, and data.

The storage device 1120 is connected to the CPU 1150 through a storage controller (not shown) connected to the bus 1135. The storage device 1120 and its associated computer-readable media provide non-volatile storage for the computer 1100. Although the description of computer-readable media contained herein refers to a storage device, such as a hard disk or CD-ROM drive, it should be appreciated by those skilled in the art that computer-readable media can be any available media that can be accessed by the computer 1100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1100 may operate in a networked environment using logical connections to remote computers through a network 1140, such as TCP/IP network such as the Internet or an intranet. The computer 1100 may connect to the network 1140 through a network interface unit 1145 connected to the bus 1135. It should be appreciated that the network interface unit 1145 may also be utilized to connect to other types of networks and remote computer systems.

The computer 1100 may also include an input/output controller 1155 for receiving and processing input from a number of input/output devices 1160, including a keyboard, a mouse, a touchscreen, a camera, a microphone, a controller, a joystick, or other type of input device. Similarly, the input/output controller 1155 may provide output to a display screen, a printer, a speaker, or other type of output device. The computer 1100 can connect to the input/output device 1160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 1120 and/or RAM 1110 of the computer 1100, including an operating system 1125 suitable for controlling the operation of a networked computer. The storage device 1120 and RAM 1110 may also store one or more applications/programs 1130. In particular, the storage device 1120 and RAM 1110 may store an application/program 1130 for providing a variety of functionalities to a user. For instance, the application/program 1130 may comprise many types of programs such as a word processing application, a spreadsheet application, a desktop publishing application, a database application, a gaming application, internet browsing application, electronic mail application, messaging application, and the like. According to an embodiment of the present invention, the application/program 1130 comprises a multiple functionality software application for providing word processing functionality, slide presentation functionality, spreadsheet functionality, database functionality and the like.

The computer 1100 in some embodiments can include a variety of sensors 1165 for monitoring the environment surrounding and the environment internal to the computer 1100. These sensors 1165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Additional information may be found in Singh G, et al, (2022) Front. Electron. 3:834146, incorporated herein by reference in its entirety.

Some embodiments of the invention are further described in detail by reference to the following example. This example is provided for purposes of illustration only, and is not intended to be limiting unless otherwise specified. Thus, the invention should in no way be construed as being limited to the following example, but rather, should be construed to encompass any and all variations which become evident as a result of the teaching provided herein.

Without further description, it is believed that one of ordinary skill in the art can, using the preceding description, and the following illustrative example, make and utilize the system and method of the present invention. The following working example therefore, specifically points out exemplary embodiments of the present invention, and is not to be construed as limiting in any way the remainder of the disclosure.

### Example: Convolutional Neural Network Inference

In this section, a convolutional neural network inference is shown to demonstrate the use of the CIDAN platform for varying bit-precision workloads and obtaining high throughput and energy efficiency. The data mapping for CNN applications is shown to achieve maximum throughput. It should be noted, however, that the CIDAN platform as disclosed herein is not limited to the inference of CNNs.

The accuracy of CNN inference tasks varies with bit-precision (McKinstry et al., Discovering low-precision networks close to full-precision networks for efficient inference. page 6-9, December 2019; Sun et al., Advances in Neural Information Processing Systems, volume 33, pages 1796-1807. Curran Associates, Inc., 2020). The accuracy is highest for floating-point representation and decreases as the bit precision is lowered to a fixed-point representation of 8 bits, 4 bits, 2 bits, and in the extreme case to 1 bit. A CNN with 1-bit precision of inputs and weights is called a Binary Neural Network (BNN) (Courbariaux & Bengio, CoRR, abs/1602.02830, 2016) and the networks with only weights being restricted to binary values are called Binary Weighted Networks (BWNs) (Courbariaux et al., Advances in neural information processing systems, pages 3123-3131, 2015). In BWNs the inputs may have bit-precision of 4-bits, 8-bits, or 16-bits. The lower precision networks substantially reduce memory requirements and computational load for hardware implementation and are in some embodiments suitable for a resource-constrained implementation. Hence, there exists a trade-off between the accuracy and the available hardware resources while selecting the bit-precision of CNNs. It will be shown below that CIDAN implements various fixed precision networks, achieving a higher throughput and energy efficiency over other implementations.

Data Mapping of CNNs onto DRAM

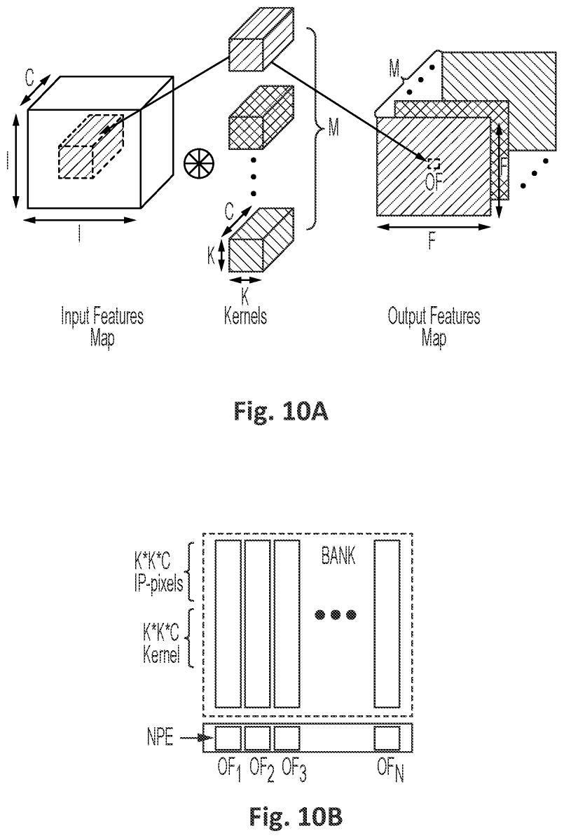

A CNN comprises three layers: a convolution layer, a pooling layer, and a fully connected layer. A convolution layer operation is depicted in FIG. 10A. In this operation, an input of dimension I*I*C is convolved with different kernels of size K*K*C to produce an output feature map of size F*F. If there are M kernels, M output feature maps are produced.

To compute one output feature (OF) a K*K*C kernel is convolved with a section of the image of the same dimensions. As all NPEs are connected to different bitlines in some disclosed architectures, they can work independently on the data residing in different rows connected to the same set of bitlines. Hence, each NPE can produce one output feature. Since all NPEs work in parallel, they can be fully utilized to produce several output features in parallel in the same number of cycles for a given layer. Therefore, the required input and kernel pixels are arranged vertically in the columns connected to an NPE. The input pixels and kernel pixels are replicated along the columns of a bank to support the parallel operation of all the NPEs to generate output feature maps. FIG. 10B shows data mapping along with vertical columns in banks, where columns act as a Single Instruction Multiple Data (SIMD) lane connected to an NPE.

The pooling and the fully connected layers can be converted to the convolution layer using the parameters I, C, K, F, M. The input is mapped to DRAM banks such that an output value can be produced by a single NPE over multiple cycles and the maximum NPEs can be used in parallel. A data mapping algorithm is designed to achieve mapping to use the maximum number of NPEs in parallel and achieve the maximum possible throughput. The data mapping algorithm may avoid, as much as possible, any movement of data from one NPE to another in a single bank as shifting of data through shared internal buffer using CPU instructions is expensive in terms of latency and energy.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A system, comprising:
a computer-readable memory;
a neuron processing element communicatively connected to the computer-readable memory, the neuron processing element comprising:
a plurality of configurable processing circuits each having a plurality of outputs and a plurality of inputs; and
a network connecting one or more of the outputs of the configurable processing circuits to one or more of the inputs of the configurable processing circuits,
each of the configurable processing circuits comprising:
an artificial neuron having a plurality of inputs; and
a register connected to the inputs of the artificial neuron.

2. The system of claim 1, further comprising a controller, communicatively connected to the neuron processing element, the controller being configured to provide configuration instructions to the neuron processing element.

3. The system of claim 2, further comprising a processor configured to send instructions to the controller, to cause the controller to provide the configuration instructions to the neuron processing element.

4. The system of claim 1, wherein the computer-readable memory is on an integrated circuit, and the neuron processing element is on the integrated circuit.

5. The system of claim 1, wherein a first configurable processing circuit of the configurable processing circuits comprises a plurality of multiplexers, each of the multiplexers having:
a plurality of data inputs, and
an output connected to a respective input of the artificial neuron of the first configurable processing circuit.

6. The system of claim 5, wherein one data input of a multiplexer of the plurality of multiplexers is connected to the output of the artificial neuron of the first configurable processing circuit.

7. The system of claim 5, wherein a respective output of each of the other artificial neurons of the neuron processing element is connected to a respective data input of a multiplexer of the plurality of multiplexers.

8. The system of claim 5, wherein a first data input of a multiplexer of the plurality of multiplexers is connected to a constant 1 and a second data input of a multiplexer of the plurality of multiplexers is connected to a constant 0.

9. The system of claim 1, wherein each of the artificial neurons has at least three inputs.

10. The system of claim 1, wherein the neuron processing element comprises at least three configurable processing circuits.

11. The system of claim 1, wherein each of the artificial neurons comprises at least two input networks, each comprising an input and an output.

12. The system of claim 11, wherein each of the artificial neurons further comprises a sense amplifier connected to the outputs of the at least two input networks of the artificial neuron.

13. The system of claim 1, wherein the neuron processing element is configured to read an input from a bank of the computer-readable memory and write a result back to the same bank of the computer-readable memory.

14. The system of claim 1, wherein the neuron processing element is configured to read an input from a first bank of the computer-readable memory and write a result back to a second bank of the computer-readable memory, the second bank being different from the first bank.

15. A method, comprising:
providing a computer-readable memory having a neuron processing element communicatively connected to the computer-readable memory, the neuron processing element comprising a plurality of artificial neurons;
storing a set of input values in a first bank of the computer-readable memory;
transmitting the set of input values and a plurality of control signals to the neuron processing element;
setting a threshold function at each of the set of artificial neurons based on the control signals;
calculating a result with the neuron processing element; and
storing the result in the computer-readable memory.

16. The method of claim 15, wherein the storing of the result in the computer-readable memory comprises storing the result in the first bank of the computer-readable memory.

17. The method of claim 15, further comprising:
calculating a set of control signals for a plurality of multiplexers in the neuron processing element; and
connecting outputs of the artificial neurons in the neuron processing element to inputs of the artificial neurons in the neuron processing element by setting select lines of the plurality of multiplexers in the neuron processing element.

18. The method of claim 15, further comprising storing an input value of the set of input values in a register in the neuron processing element.

19. The method of claim 15, further comprising:
storing a set of outputs of the artificial neurons in a register in the neuron processing element;
changing the threshold function at each of the set of artificial neurons; and
transmitting the set of outputs in the register to the inputs of the artificial neurons;
calculating a second set of outputs of the artificial neurons.

20. The method of claim 19, further comprising:
calculating a set of control signals for a plurality of multiplexers in the neuron processing element; and
connecting bits of the register in the neuron processing element to inputs of the artificial neurons in the neuron processing element by setting select lines of the plurality of multiplexers in the neuron processing element.
